(19) United States
(12) Patent Application Publication
(10) Pub. No.: US 2023/0245675 A1
(43) Pub. Date: Aug. 3, 2023

(54) ENVIRONMENT ESTIMATION APPARATUS, ENVIRONMENT ESTIMATION METHOD, AND PROGRAM

(71) Applicant: NIPPON TELEGRAPH AND TELEPHONE CORPORATION, Tokyo (JP)

(72) Inventors: Yuma KOIZUMI, Tokyo (JP); Ryo MASUMURA, Tokyo (JP); Shoichiro SAITO, Tokyo (JP)

(73) Assignee: NIPPON TELEGRAPH AND TELEPHONE CORPORATION, Tokyo (JP)

(21) Appl. No.: 17/923,523

(22) PCT Filed: May 11, 2020
(86) PCT No.: PCT/JP2020/018823

§ 371 Date: Nov. 4, 2022

(51) Int. Cl. G10L 25/51; G10L 15/08

(52) U.S. Cl. CPC G10L 25/51; G10L 15/08; G10L 2015/088

(57) ABSTRACT

To highly accurately estimate an environment in which an acoustic signal is collected without inputting auxiliary information. An input circuitry (21) inputs a target acoustic signal, which is an estimation target. An estimation circuitry (22) correlates an acoustic signal and an explanatory text for explaining the acoustic signal to estimate an environment in which the target acoustic signal is collected. The environment is an explanatory text for explaining the target acoustic signal obtained by the correlation. The correlation is so trained as to minimize a difference between an explanatory text assigned to the acoustic signal and an explanatory text obtained from the acoustic signal by the correlation.

### TECHNICAL FIELD

The present invention relates to a technique for generating a natural language text for explaining an acoustic signal.

### BACKGROUND ART

A technique for generating an explanatory text from a medium such as an acoustic signal is called “captioning”. In particular, among kinds of captioning, captioning for generating an explanatory text not of voice but of environmental sound is called “sound captioning”.

The sound captioning is a task to generate w∈N^{N}, which is a word string of N words, that explains x∈R^{L} which are observed signals at L points in a time domain (see, for example, Non-Patent Literatures 1 to 4). In Non-Patent Literatures 1 to 4, a scheme called sequence-to-sequence (Sec2Sec) using deep learning is adopted (see, for example, Non-Patent Literature 5).

First, an observed signal x is converted into some acoustic feature value sequence {φₜ∈R^{D}}ₜ₌₁^{T}. D is a dimension of an acoustic feature value and t=1, . . . , T is an index representing a time. The acoustic feature value sequence {φₜ∈R^{D}}ₜ₌₁^{T} is embedded in a vector or a matrix v=E_{θ}_{ₑ}(φ₁, . . . , φ_{T}) of another feature value space using an encoder E having a parameter θₑ. Then, v and first to n−1-th estimated words w₁, . . . , and wₙ₋₁ are input to a decoder D having a parameter θ_{d} and a generation probability p(wₙ|v, w₁, . . . , wₙ₋₁) of the n-th word wₙ is estimated.

[Math. 1]

p(wₙ|v,w₁, . . . ,wₙ₋₁)=D_{θ}_{_{d}}(v,w₁, . . . ,wₙ₋₁) (1)

Note that a softmax function is applied to a final output of the decoder D. A generation probability of an entire sentences p(w₁, . . . , w_{N}|x) is estimated by repeating above from n=2 to n=N.

$$[ Math . 2 ]$$

$$p ( {w}_{1} , … , {w}_{N} \vert x ) = {\prod }_{n = 2}^{N} p ( {w}_{n} \vert v , {w}_{1} , … , {w}_{n - 1} ) \qquad ( 2 )$$

Note that w₁ is fixed to an index corresponding to a token representing a start of sentences. Actually, the encoder E and the decoder D are implemented by a recursive neural network such as a Long short-term memory (LSTM) or a neural network using Attention called Transformer. In addition, wₙ is set as an index maximizing p(wₙ|v, w₁, . . . , wₙ₋₁) or is generated by sampling p(wₙ|v, w₁, . . . , wₙ₋₁).

Difficulty of the sound captioning is that generated texts corresponding to sound can be countlessly present. First, an example of machine learning is explained. For example, translation of an English text “A powerful car engine running with wind blowing.” into Japanese is considered. Since words “powerful”, “car”, “wind”, and “blowing” are included in the English text, it would be appropriate to translate the English text using corresponding Japanese words “chikarazuyoi/pawafuru”, “kuruma”, “kaze”, and “fuku”. Therefore, if a human translates the English text into Japanese, it would be appropriate that a translated text is, for example, “kaze ni fukarenagara hashiru, kuruma no pawafuru na enjin” or “kuruma no enjin ga chikarazuyoku kaze ni fukarenagara hashitteiru”. That is, it is inappropriate to translate texts excluding words that are keys to the texts(keywords).

On the other hand, when sound including mixed sound of engine sound and unidentified environmental sound is to be explained, it would be difficult to distinguish by sound alone whether the environmental sound is, for example, sound of wind or sound of water or it would be difficult to identify (except an expert engineer) what kind of engine the engine is. Accordingly, there are a variety of explanatory texts that could be generated from the sound, which leads to more variety of explanatory texts than translated texts. For example, besides “A powerful car engine running with wind blowing.”, “A speedboat is traveling across water.”, “A small motor runs loudly.”, and “An engine buzzing consistently.” will be allowed.

Therefore, the conventional sound captioning is often solved with a task setting that both of an acoustic signal and a keyword may be used for input. As a dataset of the sound captioning, datasets collected from YouTube (registered trademark) and free sound material collection (for example, Non-Patent Literature 6) are often used. In most cases, tags concerning the media are assigned to such data. For example, tags such as “railway”, “trains”, and “horn” are assigned to passing sound and a steam whistle of a locomotive (for example, Non-Patent Literature 7). In a dataset used in Non-Patent Literature 4, an ontology label is manually assigned to sound collected from YouTube (registered trademark). In Non-Patent Literature 4 and in a competition of the sound captioning, such tags are used as keywords and are simultaneously input to the encoder E and the decoder D to suppress diversity of explanatory texts and improve accuracy of text generation. That is, in the conventional art, the difficulty of the sound captioning is avoided by changing the task setting.

### PRIOR ART LITERATURE

### Non-Patent Literature

Non-Patent Literature 1: K. Drossos, et al., “Automated audio captioning with recurrent neural networks,” Proc. of WASPAA, 2017.
Non-Patent Literature 2: S. Ikawa, et al., “Neural audio captioning based on conditional sequence-to-sequence model,” Proc. of DCASE, 2019.
Non-Patent Literature 3: M. Wu, et al., “Audio Caption: Listen and Tell,” Proc. of ICASSP, 2019.
Non-Patent Literature 4: C. D. Kim, et al., “AudioCaps: Generating Captions for Audios in The Wild,” Proc. of NAACL-HLT, 2019.
Non-Patent Literature 5: I. Sutskever, O. Vinyals, and Q. V. Le, “Sequence to Sequence Learning with Neural Networks,” Proc. of NIPS, 2014.
Non-Patent Literature 6: K. Drossos, et al., “Clotho: An Audio Captioning Dataset,” Proc. of ICASSP, 2020.
Non-Patent Literature 7: Freesound, “Train passing by in the Wirikuta Desert (Mexico, SLP)”, [online], [searched on Apr. 27, 2020], Internet <URL: https://freesound.org/people/felix.blume/sounds/166086/>

### SUMMARY OF THE INVENTION

### Problems to be Solved by the Invention

However, the task setting that allows the input of keywords markedly limits a usable range of the sound captioning technique. For example, suppose a system that detects abnormal sound emitted by a machine and informs the detected result to a user. In this case, it is more understandable for the user and more useful for, for example, finding of a failure part to output an explanatory text such as “high-pitched sound like metal scratching sound not usually heard is heard” than to simply output a label “abnormal”. However, when keywords are necessary for explanatory text generation, a person needs to input keywords such as “metal” and “scratching”. If characteristics of the sound are known to that extent, it is no more necessary to generate an explanatory text. In order to expand a use range of the sound captioning, a technique capable of performing highly accurate explanatory text generation without inputting auxiliary information such as keywords is necessary.

In view of the technical problem described above, an object of the present invention is to, without inputting auxiliary information, highly accurately estimate an environment in which an acoustic signal is collected.

### Means to Solve the Problems

In order to solve the problem, an environment estimation method according to an aspect of the present invention includes: an input step for inputting a target acoustic signal, which is an estimation target; and an estimating step for correlating an acoustic signal and an explanatory text for explaining the acoustic signal to estimate an environment in which the target acoustic signal is collected.

### Effects of the Invention

According to the present invention, it is possible to, without inputting auxiliary information, highly accurately estimate an environment in which an acoustic signal is collected.

### BRIEF DESCRIPTION OF THE DRAWINGS

FIG. 1 is a diagram illustrating a functional configuration of an estimator training apparatus.

FIG. 2 is a diagram illustrating a processing procedure of an estimator training method.

FIG. 3 is a diagram illustrating a functional configuration of an environment estimation apparatus.

FIG. 4 is a diagram illustrating a processing procedure of an environment estimation method.

FIG. 5 is a diagram for explaining an experimental result.

FIG. 6 is a diagram illustrating a functional configuration of a computer.

### DETAILED DESCRIPTION OF THE EMBODIMENTS

[Overview of the invention]

The present invention is a technique for performing sound captioning without using auxiliary information such as keywords. That is, a simplest and practical task setting in which a pair of “sound” and “explanatory text” is given as training data and only “sound” is given as test data is considered.

As it is evident from the conventional art, it is useful for highly accurate text generation to input keywords to the sound captioning. Therefore, in the present invention, first, keywords are extracted from an explanatory text of training data and are added to the training data. Subsequently, keywords are estimated from observed sound, and a statistical model (hereinafter referred to as “estimator” as well) such as a deep neural network (DNN) is trained such that the estimated keywords coincide with the above-mentioned extracted keywords. The estimated keywords and an acoustic feature value embedded with the keywords are simultaneously input to a decoder to generate an explanatory text.

<Creation of keyword training data>

A creation procedure for keyword training data is explained. An execution procedure is as follows.

1. A correct explanatory text is subjected to word division (tokenized).
2. Parts of speech of respective divided words are estimated.
3. Word stems are obtained about only words of parts of speech designated beforehand and set as keywords. The parts of speech used here may be any parts of speech. For example, a noun, a verb, an adverb, an adjective and so on are applicable.

If too many keywords are obtained by the above procedure, only frequently appearing words may be selected as keywords by repeating the procedure to all training data, and counting the numbers of times of appearance of extracted respective words.

Suppose a text “A muddled noise of broken channel of the TV.” for example. Words corresponding to any one of the noun, the verb, the adverb, and the adjective are “muddled”, “noise”, “broken”, “channel”, and “TV”. Word stems of these words are respectively “muddle”, “noise”, “break”, “channel”, and “TV”. Therefore, keywords of “A muddled noise of broken channel of the TV.” are “muddle”, “noise”, “break”, “channel”, and “TV”.

<Keyword Estimation>

A type of a keyword is represented as K and a vector representing a keyword assigned to observed sound x (hereinafter referred to as “keyword vector” as well) is represented as h∈N^{K}, where k is a binary vector, a k-th dimension of which is 1 if a k-th keyword is included and is 0 if the k-th keyword is not included.

A purpose herein is to highly accurately estimate the keyword vector h from an acoustic feature value sequence {φₜ∈R^{D}}ₜ₌₁^{T} extracted from the observed sound x. The simplest idea is to prepare an estimator with parameter θₐ which estimates keywords and to have the estimator produce h=Aθₐ(φ₁, . . . , φ_{T}). However, the size of T is variable depending on input sound, so it is not easy to convert T into a fixed-length vector. It is assumed that sound corresponding to keywords such as “background” and “engine” lasts for a long time and, on the other hand, sound corresponding to keywords such as “door” and “knock” last only for a short time. That is, in the sense of signal processing/statistical processing of sound, it makes more sense to estimate a keyword at every time t. If a label of the keyword is available at every time t, training of an estimator for the label is easy (called “strong label learning”). However, under the task setting of the present invention, a label of one keyword is assigned only to an entire time sequence. Therefore, in the present invention, an estimation method is designed with reference to an acoustic event detection task with weak label.

First, p(z_{t,k}|x), which is a probability of presence of sound related to a k-th keyword at time t, is estimated as follows using the estimator A.

[Math. 3]

p(z_{t,k}|x)=A_{θ}_{ₐ}(ϕ₁, . . . ,ϕ_{T}) (3)

Note that A:R^{D×T}→R^{K×T}, whose activation function of the output layer is a sigmoid function.

Next, (p(zₖ|x), which is a probability of presence of the k-th keyword in an acoustic feature value sequence, is estimated by integrating p(z_{t,k}|x) in a time direction. As an integrating method, various methods such as averaging in the time direction are conceivable. The integrating method may be any method, but, for example, a method of selecting a maximum value as follows is recommended.

$$[ Math . 4 ]$$

$$p ( {z}_{k} \vert x ) = {max}_{t} p ( {z}_{t , k} \vert x ) \qquad ( 4 )$$

Then, the parameter θₐ is optimized to minimize the following weighted binary cross entropy.

$$[ Math . 5 ]$$

$${ℒ}_{key} = - \frac{1}{K} {\sum }_{k = 1}^{K} λ {h}_{k} ln ( p ( {z}_{k} \vert x ) ) + γ ( 1 - {h}_{k} ) ln ( 1 - p ( {z}_{k} \vert x ) ) \qquad ( 5 )$$

Weight coefficients λ and γ are defined as inverses of appearance frequencies as follows.

$$[ Math . 6 ]$$

$$λ = \frac{1}{p ( {h}_{k} )} , γ = \frac{1}{1 - p ( {h}_{k} )} \qquad ( 6 )$$

In addition, p(hₖ) is calculated as follows as a ratio of appearance of the k-th keyword in training data.

$$[ Math . 7 ]$$

$$p ( {h}_{k} ) = \frac{\begin{matrix}Number of appearances of the k - th \\ keyword in training data\end{matrix}}{Number of training data} \qquad ( 7 )$$

Note that formula (5) is described as being calculated from one sample. However, actually, training is performed to minimize an average of plural samples (minibatch).

<Explanatory Text Generation Together with Estimated Keywords>

M keywords are selected from p(zₖ|x) in order to input the keywords for explanatory text generation. Several methods of realizing this are conceivable. However, any method may be used. For example, it is conceivable to sort p(zₖ|x) and select M keywords in order that have higher probability. The M keywords selected in this way are embedded in a feature value space using some kind of word embedding method to obtain M keyword feature value vectors {yₘ∈R^{D}}ₘ₌₁^{M}. The keyword feature value vectors {yₘ∈R^{D}}ₘ₌₁^{M} are input to the encoder E and the decoder D to generate an explanatory text. For example, the following can be used as a simple method of the implementation.

[Math. 8]

p(wₙ|v,w₁, . . . ,wₙ₋₁)=D_{θ}_{_{d}}(v,y₁, . . . ,y_{M},w₁, . . . ,wₙ₋₁) (8)

The parameters θₑ, θ_{d}, and θₐ are trained to minimize some kind of objective function. For example, a sum of cross entropy between a generated explanatory text and a manually assigned correct explanatory text, and a keyword estimation error L_{key} of formula (5) can be used as the objective function.

$$[ Math . 9 ]$$

$$ℒ = \frac{1}{N - 1} {\sum }_{n = 2}^{N} CE ( {w}_{n} , p ( {w}_{n} \vert v , {w}_{1} , … , {w}_{n - 1} ) ) + {ℒ}_{key} \qquad ( 9 )$$

Note that CE(a, b) is cross entropy calculated from a and b.

Following three items are the points of the present invention.

Point 1. Keywords are extracted from a correct explanatory text according to a heuristic rule. Only predetermined parts of speech such as “noun, verb, adjective, and adverb” are used after the correct explanatory text is subjected to word division and parts of speech estimation. The words are transformed into word stems and counted in all training data. Frequently appearing words are used as keywords.

Point 2. Estimation of keywords is solved as an acoustic event detection task with weak label. Sound information relating to keywords may be included in entire input sound data or may be included in only a part of the input sound data. In order to highly accurately detect sound (for example, door sound) included in only a part of the input sound data, a strong label (a type+occurrence time of the sound) indicating from what second to what second the sound lasted is necessary. However, time cannot be known by the method of the point 1. Therefore, the estimation of keywords follows task setting of acoustic event detection with weak label where an occurrence probability of sound relating to keywords are calculated at every time but training is performed in a way of integrating time periods. A training method is devised to make it possible to highly accurately estimate keywords.

Point 3. The estimated keywords are embedded in a feature value space trained beforehand and are input to a decoder. There are several types of embedding methods. One of the types of those methods is explained in an embodiment.

### Embodiment

An embodiment of the present invention is explained in detail below. Note that, in the drawings, components having the same functions are denoted by the same numbers and redundant explanation of the components is omitted.

The embodiment of the present invention includes an estimator training apparatus and an estimator training method for training, using a training dataset consisting of a pair of an acoustic signal and a correct explanatory text, parameters of an estimator that generates an explanatory text from the acoustic signal; and an environment estimation apparatus and an environment estimation method for estimating, using the estimator trained by the estimator training apparatus and the estimator training method, an environment in which the acoustic signal is collected from the acoustic signal.

<Estimator Training Apparatus>

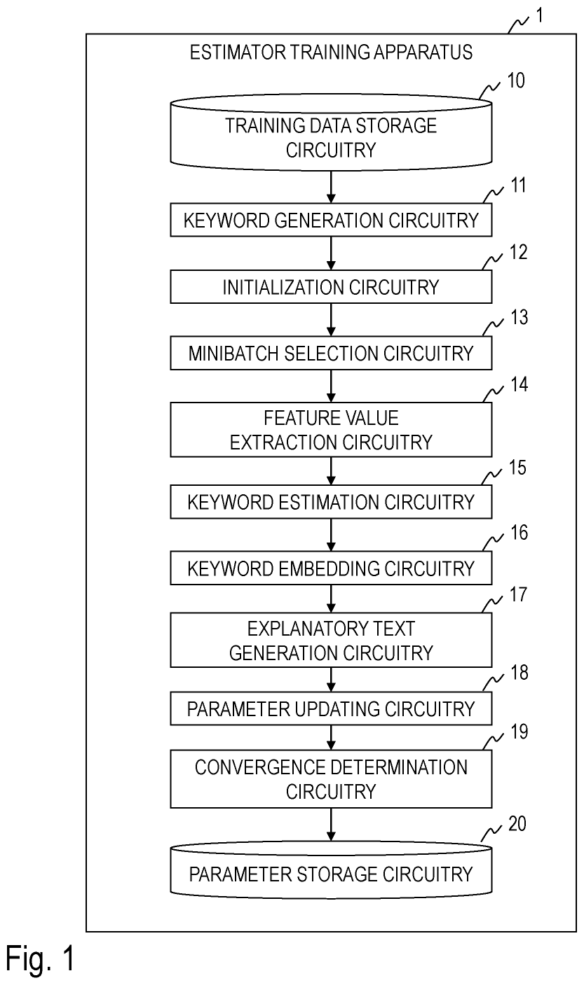

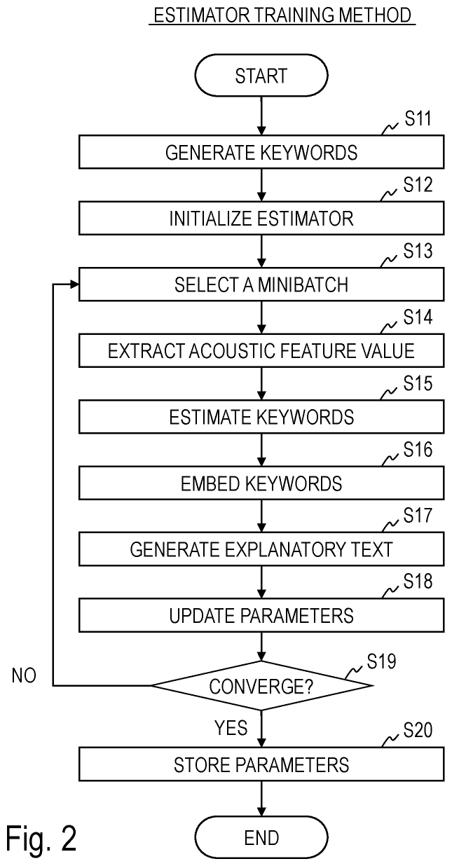

As illustrated in FIG. 1, an estimator training apparatus 1 in the embodiment includes, for example, a training data storage circuitry 10, a keyword generation circuitry 11, an initialization circuitry 12, a minibatch selection circuitry 13, a feature value extraction circuitry 14, a keyword estimation circuitry 15, a keyword embedding circuitry 16, an explanatory text generation circuitry 17, a parameter updating circuitry 18, a convergence determination circuitry 19, and a parameter storage circuitry 20. The estimator training apparatus 1 executes steps illustrated in FIG. 2, whereby the estimator training method in the embodiment is realized.

The estimator training apparatus 1 is a special device configured by reading a special program into a publicly-known or dedicated computer including, for example, a central processing unit (CPU) and a main storage device (RAM: Random Access Memory). For example, the estimator training apparatus 1 executes respective kinds of processing under control by the central processing unit. Data input to the estimator training apparatus 1 and data obtained by the respective kinds of processing are stored in, for example, the main storage device. The data stored in the main storage device is read out to the central processing unit and used for other processing according to necessity. At least a part of the processing circuitry of the estimator training apparatus 1 may be configured by hardware such as an integrated circuit. The storage circuitry included in the estimator training apparatus 1 can be configured by a main storage device such as a RAM (Random Access Memory), an auxiliary storage device configured by a semiconductor memory element such as a hard disk, an optical disk, or a flash memory, or middleware such as a relational database or a key-value store.

The estimator training method executed by the estimator training apparatus 1 in the embodiment is explained below with reference to FIG. 2.

In the training data storage circuitry 10, a training dataset consisting of a plural training data is stored. The training data includes acoustic signals collected in advance and a correct explanatory text manually assigned to the acoustic signals.

In step S10, the estimator training apparatus 1 reads out the training dataset stored in the training data storage circuitry 10. The read-out training dataset is input to the keyword generation circuitry 11.

In step S11, the keyword generation circuitry 11 generates keywords corresponding to explanatory texts from the input training dataset. A keyword generation method follows the procedure explained in <creation of keyword training data> above. The keyword generation circuitry 11 assigns the generated keywords to acoustic signals and explanatory texts of training data and stores the keywords in the training data storage circuitry 10.

In step S12, the initialization circuitry 12 initializes parameters θₑ, θ_{d}, and θₐ of an estimator with a random number or the like.

In step S13, the minibatch selection circuitry 13 selects a minibatch of approximately one hundred samples at random from the training dataset stored in the training data storage circuitry 10. The minibatch selection circuitry 13 outputs the selected minibatch to the feature value extraction circuitry 14.

In step S14, the feature value extraction circuitry 14 extracts acoustic feature values from the acoustic signals included in the minibatch. The feature value extraction circuitry 14 outputs the extracted acoustic feature values to the keyword estimation circuitry 15.

In step S15, the keyword estimation circuitry 15 estimates keywords from the input acoustic feature values. A keyword estimation method follows the procedure explained in <keyword estimation> above. The keyword estimation circuitry 15 outputs the generated keywords to the keyword embedding circuitry 16.

In step S16, the keyword embedding circuitry 16 embeds the input keywords in a feature value space and generates keyword feature value vectors. The keyword embedding circuitry 16 outputs the generated keyword feature value vectors to the explanatory text generation circuitry 17.

In step S17, the explanatory text generation circuitry 17 generates an explanatory text using the input keyword feature value vectors. An explanatory text generation method follows the procedure explained in <explanatory text generation together with estimated keywords> above. The explanatory text generation circuitry 17 outputs the generated explanatory text to the parameter updating circuitry 18.

In step S18, the parameter updating circuitry 18 updates the parameters θₑ, θ_{d}, and θₐ of the estimator to reduce an average of cost function Ls of formula (9) within the minibatch.

In step S19, the convergence determination circuitry 19 determines whether an end condition set in advance is satisfied. The convergence determination circuitry 19 advances the processing to step S20 if the end condition is satisfied and returns the processing to step S13 if the end condition is not satisfied. It is enough as the end condition that, for example, parameter update is executed a predetermined number of times.

In step S20, the estimator training apparatus 1 stores the learned parameters θₑ, θ_{d}, and θₐ in the parameter storage circuitry 20.

<Environment Estimation Apparatus>

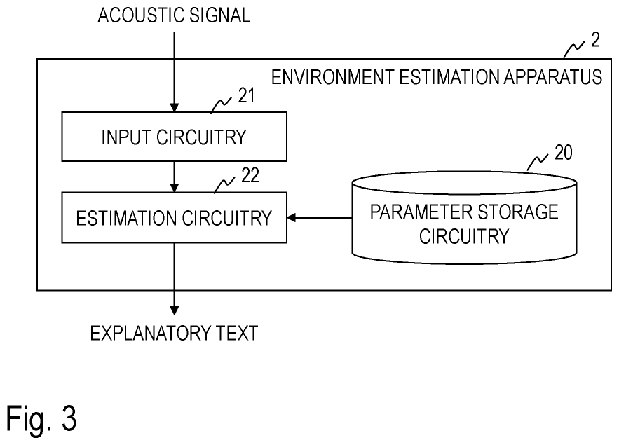

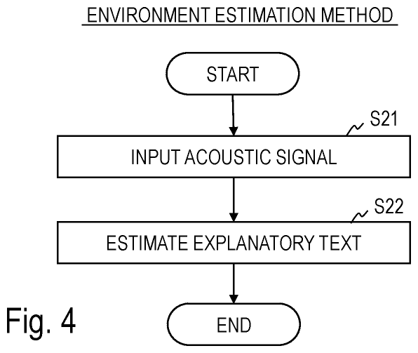

As illustrated in FIG. 3, an environment estimation apparatus 2 in the embodiment receives an input of an estimation target acoustic signal and outputs an explanatory text for explaining the acoustic signal. The environment estimation apparatus 2 includes, for example, a parameter storage circuitry 20, an input circuitry 21, and an estimation circuitry 22. The environment estimation apparatus 2 executes steps illustrated in FIG. 4, whereby the environment estimation method in the embodiment is realized.

The environment estimation apparatus 2 is a special device configured by reading a special program into a publicly-known or dedicated computer including, for example, a central processing unit (CPU) and a main storage device (RAM: Random Access Memory). For example, the environment estimation apparatus 2 executes respective kinds of processing under control by the central processing unit. Data input to the environment estimation apparatus 2 and data obtained by the respective kinds of processing are stored in, for example, the main storage device. The data stored in the main storage device is read out to the central processing unit and used for other processing according to necessity. At least a part of the processing circuitry of the environment estimation apparatus 2 may be configured by hardware such as an integrated circuit. The storage circuitry included in the environment estimation apparatus 2 can be configured by a main storage device such as a RAM (Random Access Memory), an auxiliary storage device configured by a semiconductor memory element such as a hard disk, an optical disk, or a flash memory, or middleware such as a relational database or a key-value store.

The environment estimation method executed by the environment estimation apparatus 2 in the embodiment is explained below with reference to FIG. 4.

The parameters θₑ, θ_{d}, and θₐ of the estimator trained by the estimator training apparatus 1 are stored in the parameter storage circuitry 20.

In step S21, a target acoustic signal, which is an estimation target, is input to the input circuitry 21. It is assumed that the target acoustic signal is not voice but is environmental sound. The input circuitry 21 outputs the input target acoustic signal to the estimation circuitry 22.

In step S22, the estimation circuitry 22 inputs the input target acoustic signal to the estimator, which uses the learned parameters θₑ, θ_{d}, and θₐ stored in the parameter storage circuitry 20, and estimates an explanatory text for explaining the target acoustic signal. Since the target acoustic signal is the environmental sound, the estimated explanatory text is a natural language text for explaining environment in which the target acoustic signal is collected. Note that the environment means environment including acoustic events and/or non-acoustic events that occur around a place where the target acoustic signal is collected. The estimation circuitry 22 sets the estimated explanatory text as output from the environment estimation apparatus 2.

[Experimental Result]

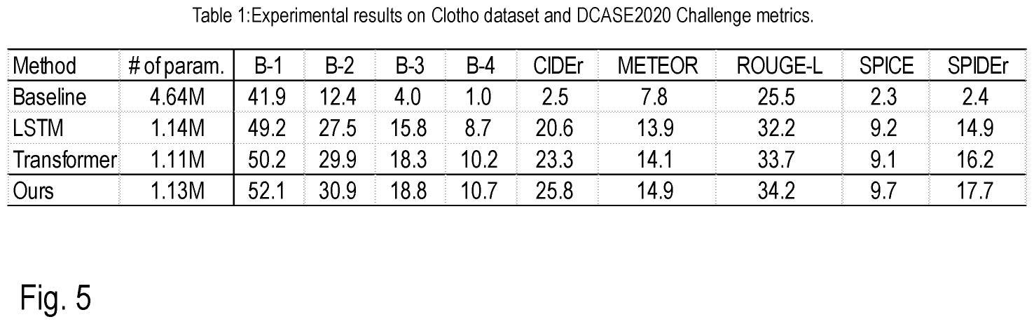

In FIG. 5, a result obtained by performing an experiment using a Clotho dataset (Non-Patent Literature 6) in order to check effectiveness of the present invention is illustrated. As evaluation indicators, the same evaluation indicators (BLEU₁, BLEU₂, BLEU₃, and BLEU₄ (described as B-1, B-2, B-3, and B-4 in the figure) and CIDEr, METEOR, and ROUGE_{L} (described as ROUGE-L in the figure), and SPICE and SPIDEr) as the evaluation indicators of DCASE2020 Challenge task 6 are used. Compared methods are a baseline system (“Baseline” in the figure) of DCASE2020 Challenge task 6 and a Sec2Sec model using an LSTM and a transformer (“LSTM”, “Transformer” in the figure). In the present invention, keyword estimation is used in latter stage of an encoder of the transformer and estimated words are simultaneously input to the decoder as indicated by formula (8). “# of param” is the number of parameters used in each method. Numerical values described in rows of each method are scores by each evaluation indicator. Larger values indicate that accuracy is higher.

As it is seen from FIG. 5, in the present invention, explanatory text estimation can be highly accurately performed with the number of parameters smaller than the number of parameters of the baseline system. It is seen that the explanatory text estimation can be highly accurately performed with the almost same number of parameters compared with the LSTM and the Transformer that do not use keyword estimation.

The embodiment of the present invention is explained above. However, a specific configuration is not limited to the embodiment. It goes without saying that, even if design changes and the like are performed as appropriate in a range not departing from the gist of the present invention, the design changes and the like are included in the present invention. The various kinds of processing explained in the embodiment are not only executed in time series according to the described order but also may be executed in parallel or individually according to a processing ability of a device that executes the processing or according to necessity.

[Program, Recording Medium]

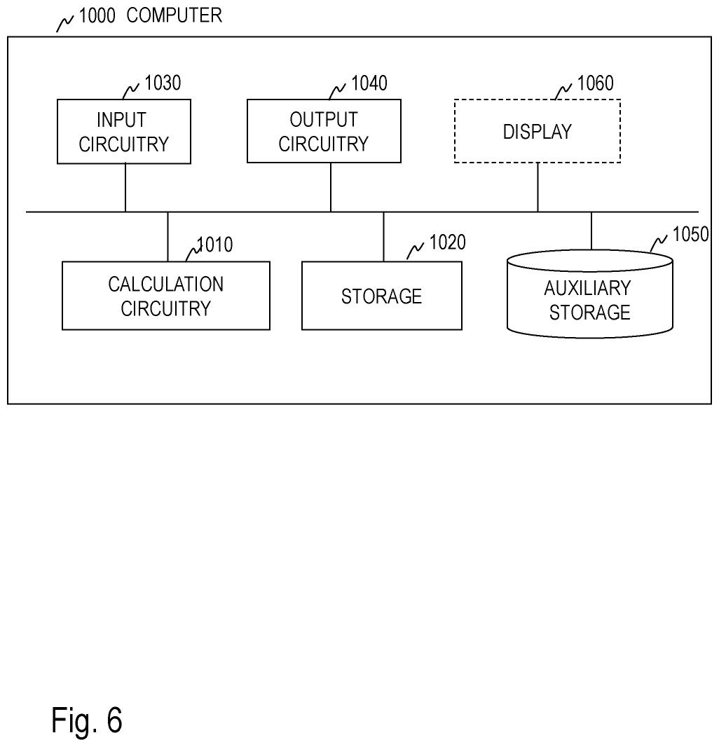

When the various processing functions in the apparatuses explained in the embodiment are realized by a computer, processing contents of the functions that each apparatuses should have are described by a program. The various processing functions in the apparatuses are realized on the computer by causing a storage 1020 of the computer illustrated in FIG. 6 to read the program and causing calculation circuitry 1010, input circuitry 1030, output circuitry 1040, and the like to operate.

The program describing the processing content can be recorded in a computer-readable recording medium. The computer-readable recording medium is, for example, a non-transitory recording medium and is a magnetic recording device, an optical disk, or the like.

Distribution of the program is performed by, for example, selling, transferring, or lending a portable recording medium such as a DVD or a CD-ROM recording the program. Further, the program may be distributed by storing the program in a storage device of a server computer and transferring the program to another computer from the server computer via a network.

For example, first, the computer that executes such a program once stores the program recorded in the portable recording medium or the program transferred from the server computer in an auxiliary storage 1050, which is a non-transitory storage device of the computer. When processing is executed, the computer reads the program stored in the auxiliary storage 1050, which is the non-transitory storage device of the computer, into the storage 1020, which is a transitory storage device, and executes processing conforming to the read program. As another execution form of the program, the computer may directly read the program from the portable recording medium and execute the processing conforming to the program. Further, every time the program is transferred to the computer from the server computer, the computer may sequentially execute the processing conforming to the received program. The processing explained above may be executed by a service of a so-called ASP (Application Service Provider) type for not performing the transfer of the program to the computer from the server computer and realizing the processing function according to only an execution instruction and result acquisition of the program. Note that the program in this form includes information served for processing by an electric computer and equivalent to the program (data or the like that is not a direct instruction to the computer but has a characteristic of defining the processing of the computer).

In this form, the apparatuses are configured by causing the computer to execute the predetermined program. However, at least a part of the processing contents may be realized in a hardware manner.

1. An environment estimation method comprising:
an input step for inputting a target acoustic signal, which is an estimation target; and
an estimating step for correlating an acoustic signal and an explanatory text for explaining the acoustic signal to estimate an environment in which the target acoustic signal is collected, wherein
the environment includes an acoustic event and/or a non-acoustic event that occurs around a place where the target acoustic signal is collected.

2. (canceled)

3. The environment estimation method according to claim 1, wherein
the environment is an explanatory text for explaining the target acoustic signal obtained by the correlation, and
the correlation is so trained as to minimize a difference between an explanatory text assigned to the acoustic signal and an explanatory text obtained from the acoustic signal by the correlation.

4. The environment estimation method according to claim 3, wherein the correlation is performed using, as a label of the acoustic signal, a keyword for explaining the acoustic signal extracted from the explanatory text.

5. The environment estimation method according to claim 4, wherein the correlation is performed using a probability that a candidate keyword, which is obtained using the correlation and is a candidate of keyword for explaining the acoustic signal, is included in the acoustic signal.

6. An environment estimation apparatus comprising:
an input circuitry that inputs a target acoustic signal, which is an estimation target; and
an estimation circuitry that correlates an acoustic signal and an explanatory text for explaining the acoustic signal to estimate an environment in which the target acoustic signal is collected, wherein
the environment includes an acoustic event and/or a non-acoustic event that occurs around a place where the target acoustic signal is collected.

7. A non-transitory computer-readable recording medium which stores a program for causing a computer to function as the environment estimation apparatus according to claim 6.
